(19) United States
(12) Patent Application Publication
(10) Pub. No.: US 2013/0120722 A1
(43) Pub. Date: May 16, 2013

(54) METHOD AND SYSTEM FOR FORMING ALIGNMENT FILM REGION THROUGH UV LIGHT EXPOSURE

(71) Applicant: Yu Song, Shenzhen (CN)

(72) Inventor: Yu Song, Shenzhen (CN)

(73) Assignee: SHENZHEN CHINA STAR OPTOELECTRONICS TECHNOLOGY CO., LTD., Shenzhen (CN)

(21) Appl. No.: 13/380,216

(22) PCT Filed: Nov. 17, 2011
(86) PCT No.: PCT/CN2011/082354

§ 371 Date: Dec. 22, 2011

(30) Foreign Application Priority Data
Nov. 14, 2011 (CN) 201110357645.7

(51) Int. Cl. G03B 27/32

(52) U.S. Cl. 355/27

(57) ABSTRACT

A method and a system for forming an alignment film region through ultraviolet (UV) light exposure are disclosed. The method comprises the following steps of: coating a polyimide (PI) solution on a substrate to form an alignment film that covers a predetermined alignment film region on the substrate; placing a mask—above the alignment film; peeling off portions of the alignment film on the substrate that are located outside the predetermined alignment film region through exposure to a UV light; and removing the mask to obtain the alignment film. The present disclosure can effectively improve-the problems of printing offsets, sawtooth-like edge irregularities and uneven film thicknesses caused when the alignment film region is coated by an alignment film inkjet printer. This improves the positioning precision of the alignment film region and the quality of the alignment film, thus improving the image quality of the LCD device.

### BACKGROUND

1. Technical Field

The present disclosure relates to the field of technologies for forming an alignment film in a liquid crystal display (LCD) device, and more particularly, to a method and a system for forming an alignment film through ultraviolet (UV) light exposure.

2. Description of Related Art

A conventional LCD device generally comprises a thin film transistor (TFT) substrate (i.e., a lower substrate) for forming pixel electrodes, a color filter (CF) substrate (i.e., an upper substrate) for forming common electrodes, and a liquid crystal layer sandwiched between the TFT substrate and the CF substrate. In order to arrange liquid crystal molecules into a specific orientation, each of the substrates is coated with an alignment film on an inner surface thereof to restrict the orientation statuses of the liquid crystal molecules.

During the process of coating the alignment film, a specified region of the corresponding substrate must be covered by the alignment film. Each of the substrates is divided into a plurality of displaying units of a fixed size as shown in FIG. 1. FIG. 1 is a schematic view illustrating a position of an alignment film region in a substrate in the conventional LCD panel design. An alignment film region on each of the displaying units of the fixed size on the substrate 20 must cover an effective displaying region 30 (i.e., a rectangular region defined by lines A-A and B-B in FIG. 1), but shall not cover a site coated by a sealant 10 (i.e., a black region shown in FIG. 1). According to the design rule of the alignment film region, an alignment film coating region for an alignment film inkjet printer is determined so that the alignment film can cover the alignment film region specified by the design rule. After the effective displaying region 30 (i.e., the rectangular region defined by the lines A-A and B-B in FIG. 1) on the substrate 20 is completely coated with the alignment film, the sealant 10 is coated at the coating site of the sealant 10. In other words, the coating site of the sealant 10 is usually not allowed to be coated with the alignment film.

However, the alignment film region formed through the aforesaid process has the following shortcomings

1. Coating errors (i.e., printing offsets) often exist for the alignment film coated by the alignment film inkjet printer according to the design rule. Specifically, sometimes the alignment film region actually coated cannot accurately cover the region originally specified in the design rule or even extends to the coating site of the sealant 10.

2. Sawtooth-like edge irregularities and uneven film thicknesses may be caused at edges of the alignment film due to various physical and chemical factors when the alignment film is formed. This leads to degradation of the image quality of the LCD device. Currently, the only way to improve the edge irregularities and the uneven film thicknesses is to alter coating parameters and drying parameters, but this may make the fabricating process of the alignment film complex.

### BRIEF SUMMARY

The primary objective of the present disclosure is to provide a method and a system for forming an alignment film region through ultraviolet (UV) light exposure, which are intended to avoid the problems of printing offsets, sawtooth-like edge irregularities and uneven film thicknesses caused when the alignment film region is formed in the prior art.

To achieve the aforesaid objective, the present disclosure provides a method for forming an alignment film region through UV light exposure, which comprises the following steps of:

coating a polyimide (PI) solution on a substrate to form an alignment film that covers a predetermined alignment film region on the substrate;

placing a mask fabricated according to the predetermined alignment film region above the alignment film so that the predetermined alignment film region is masked by the mask;

peeling off portions of the alignment film on the substrate that are located outside the predetermined alignment film region through exposure to a UV light; and

removing the mask to obtain the alignment film in the predetermined alignment film region.

Preferably, the step of coating a PI solution on a substrate to form an alignment film comprises:

coating the PI solution on the substrate by using an alignment film inkjet printer so that the predetermined alignment film region on the substrate is covered by the PI solution; and

pre-baking, inspecting and hardening the PI solution on the substrate to form the alignment film.

Preferably, the PI solution is comprised of polyimide and a solvent of DMA, NMP or BC.

Preferably, a distance between the mask and the substrate is smaller than or equal to 50 micrometers (μm).

Preferably, the UV light has a wavelength ranging between 146 nanometers (nm) and 365 nm.

Preferably, the substrate is a thin film transistor (TFT) substrate and/or a color filter (CF) substrate.

The present disclosure further provides a system for forming an alignment film region through UV light exposure, which comprises:

a coating apparatus for coating a PI solution on a substrate to form an alignment film;

a mask placing apparatus for placing a pre-fabricated mask above the substrate so that the predetermined alignment film region is masked by the mask; and

a UV light exposing apparatus for irradiating a UV light on the whole substrate covered by the mask to peel off portions of the alignment film on the substrate that are located outside the predetermined alignment film region.

Preferably, the coating apparatus comprises: an alignment film inkjet printer for coating the PI solution on the substrate, and an alignment film processing unit for pre-baking, inspecting and hardening the PI solution on the substrate to form the alignment film.

Preferably, a distance between the mask and the substrate is smaller than or equal to 50 μm; and the UV light has a wavelength ranging between 146 nm and 365 nm.

Preferably, the substrate is a TFT substrate and/or a CF substrate.

The method and the system for forming an alignment film region through UV light exposure according to the present disclosure can effectively make an improvement on the problems of printing offsets, sawtooth-like edge irregularities and uneven film thicknesses caused when the alignment film is coated by an alignment film inkjet printer according to the alignment film design rule in the prior art. This improves the positioning precision of the alignment film region and the quality of the alignment film, thus improving the image quality of the LCD device.

### BRIEF DESCRIPTION OF THE DRAWINGS

FIG. 1 is a schematic view illustrating a position of an alignment film region in a substrate in the conventional LCD panel design;

FIG. 2 is a schematic flowchart diagram of a preferred embodiment of a method for forming an alignment film region through UV light exposure according to the present disclosure;

FIG. 3 is a schematic view illustrating a substrate after being completely coated with an alignment film in the preferred embodiment of the method for forming an alignment film region through UV light exposure according to the present disclosure;

FIG. 4 is a schematic view illustrating the substrate completely coated with the alignment film after being covered by a mask in the preferred embodiment of the method for forming an alignment film region through UV light exposure according to the present disclosure;

FIG. 5 is a schematic view illustrating the alignment film region formed on the substrate in the preferred embodiment of the method for forming an alignment film region through UV light exposure according to the present disclosure;

FIG. 6 is a schematic flowchart diagram of a step for coating a PI solution on the whole substrate to form the alignment film in the preferred embodiment of the method for forming an alignment film region through UV light exposure according to the present disclosure; and

FIG. 7 is a schematic structural view of a system for forming an alignment film region through UV light exposure according to the present disclosure.

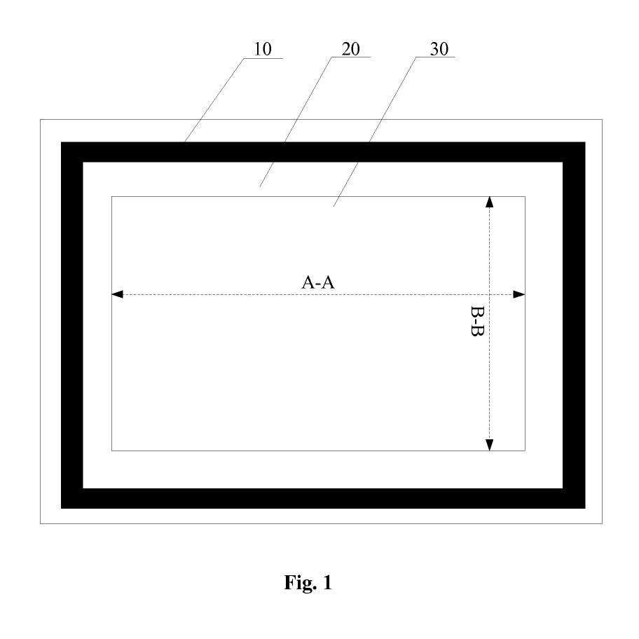

Hereinafter, implementations, functional features and advantages of the present disclosure will be further described with reference to embodiments thereof and the attached drawings.

### DETAILED DESCRIPTION

The present disclosure will be described in detail hereinbelow with reference to the attached drawings and embodiments thereof. It shall be understood that, the embodiments described herein are only intended to illustrate but not to limit the present disclosure.

The solution of the embodiments of the present disclosure is achieved primarily in the following way: coating a polyimide (PI) solution on a substrate to form an alignment film that covers a predetermined alignment film region on the substrate; covering a pre-fabricated mask on the alignment film of the substrate, wherein the mask has the same size as the predetermined alignment film region on the substrate; then, peeling off redundant portions of the alignment film on the substrate that are located outside the alignment film region through exposure to an ultraviolet (UV) light; and removing the mask to obtain the alignment film in the predetermined alignment film region.

In the embodiments of the present disclosure, the substrate may be a thin film transistor (TFT) substrate and a color filter (CF) substrate.

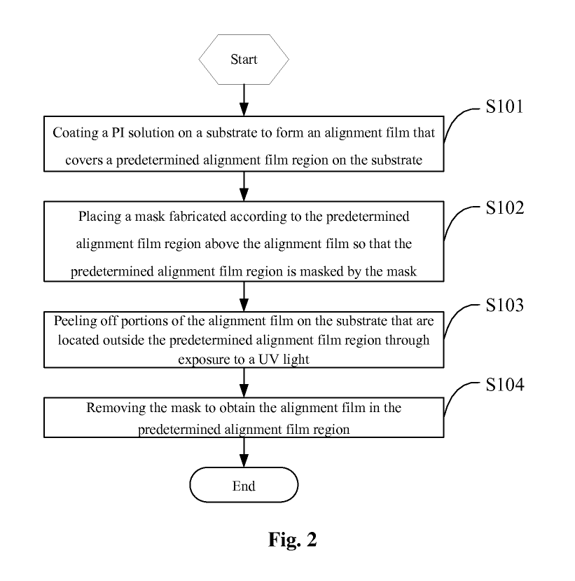

Referring to FIG. 2, there is shown a schematic flowchart diagram of a preferred embodiment of a method for forming an alignment film region through UV light exposure according to the present disclosure. The method for forming an alignment film region through UV light exposure according to this embodiment comprises steps S101, S102, S103 and S104.

Step S101: coating a PI solution on a substrate to form an alignment film that covers a predetermined alignment film region on the substrate.

In order to avoid the problems of printing offsets, sawtooth-like edge irregularities and uneven film thicknesses caused when the alignment film region is coated by an alignment film inkjet printer according to the alignment film design rule in the prior art, this embodiment uses the alignment film inkjet printer to coat the alignment film on the whole substrate completely so as to cover the predetermined alignment film region on the substrate instead of coating the alignment film according to the design rule of the alignment film region. In other embodiments, it may also be possible to simply cover the predetermined alignment film region completely instead of coating the alignment film on the whole substrate completely.

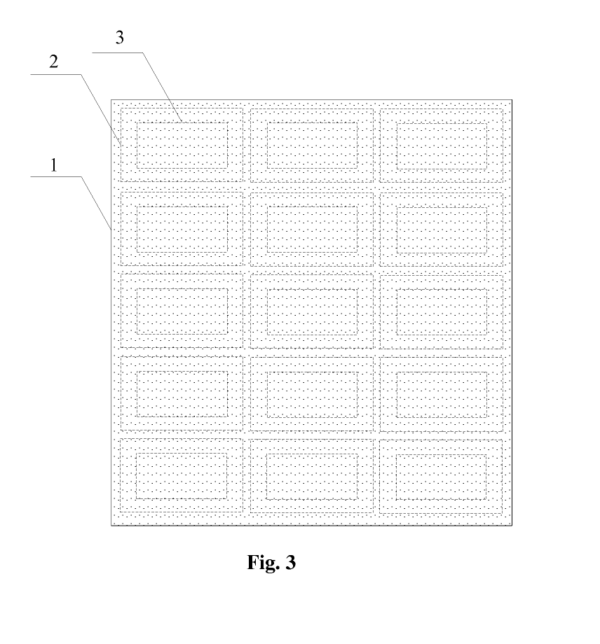

The predetermined alignment film region is a region on the substrate that is predetermined to be coated with an alignment film according to the design rule. Specifically, the PI solution is firstly coated on the whole substrate by using the alignment film inkjet printer so that the predetermined alignment film region on the substrate is covered by the PI solution; and then, the PI solution on the substrate is pre-baked, inspected and hardened to form the alignment film. The substrate array that is completely coated with the alignment film is shown in FIG. 3. As shown in FIG. 3, the entire substrate 1 is divided into a plurality of displaying units of a fixed size; rectangular boxes 2 each represent a boundary line of one of the displaying units of the fixed size; and rectangular boxes 3 each represent a boundary line of an effective displaying region on one of the displaying units of the fixed size that must be covered by the alignment film (i.e., the region in which each of the rectangular boxes 3 is located is the predetermined alignment film region). A coating site (not shown) of a sealant is reserved between each of the rectangular boxes 2 and a corresponding one of the rectangular boxes 3. In this embodiment, the alignment film is firstly coated on the entire substrate 1 shown in FIG. 3 uniformly.

In other embodiments, it may also be possible to coat the alignment film in each of the displaying units of the fixed size so long as the coated alignment film covers the predetermined alignment film region completely (i.e., so long as the PI solution for fabricating the alignment film covers the region in which each of the rectangular boxes 3 of FIG. 3 is located).

The PI solution may be comprised of polyimide and a solvent of N, N-Dimethyl Acetamide (DMA), N-Methyl Pyrrolidone (NMP) or Butyl carbonate (or Butyl carbitol; BC).

The aforesaid pre-baking process means to vaporize the solvent of DMA, NMP or BC in the PI solution.

The hardening process means to heat the PI solution to a high temperature so that polyimide in the PI solution undergoes a cyclopolymerization reaction to form polyamide that is a long-chain large-molecule solid polymer having many branched chains. An angle included between one of the branched chains and the main chain in the polymer molecule is a pretilt angle of a guiding layer. The branched chains of the polymer and liquid crystal molecules have a strong acting force therebetween, which can anchor the liquid crystal molecules and may have the liquid crystal molecules arranged in the direction of the pretilt angle.

Step S102: placing a mask fabricated according to the predetermined alignment film region above the alignment film so that the predetermined alignment film region is masked by the mask.

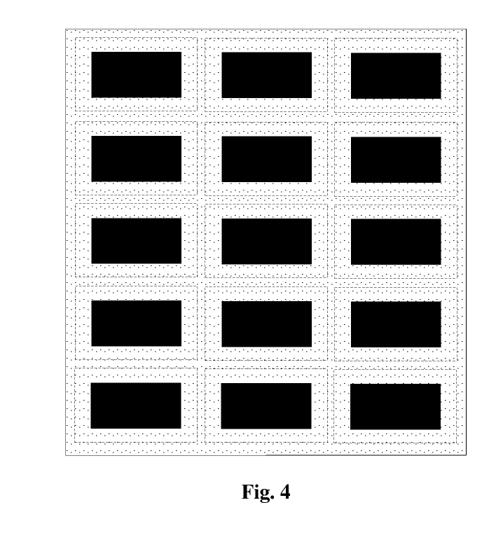

The mask has the same size as the predetermined alignment film region on the substrate. When the substrate is completely coated with the alignment film, the pre-fabricated mask is placed above the alignment film of the substrate, and the pre-fabricated mask shall be close to the substrate as far as possible to prevent light leakage due to a too large gap but shall not contact the alignment film on the substrate. In this embodiment, a distance between the mask and the substrate is usually set to be smaller than or equal to 50 micrometers (μm). The predetermined alignment film region on the substrate is completely covered by the mask (i.e., edges of the mask are substantially aligned with edges of the predetermined alignment film region) so that the predetermined alignment film region on the substrate can be masked by the mask, as shown in FIG. 4. In FIG. 4, black regions each are the mask.

Step S103: peeling off portions of the alignment film on the substrate that are located outside the predetermined alignment film region through exposure to a UV light.

Step S104: removing the mask to obtain the alignment film in the predetermined alignment film region.

In the step S103 and the step S104, the UV light is used to irradiate the entire surface of the substrate that is covered with the mask and to remove redundant portions of the alignment film on the substrate that are located outside the predetermined alignment film region.

The UV light generally has a wavelength ranging between 146 nanometers (nm) and 365 nm. The UV light can excite oxygen (O₂) in the air into ozone (O₃) having strong oxidizability, and also break a molecular chain of polyamide of the large-molecule solid polymer into small polyamide molecules. The polyamide molecules are oxidized by ozone into such gases as H₂O₂, CO₂ and NOₓ, which are exhausted by an exhaust apparatus that is additionally provided. In this way, the portions of the alignment film can be removed by using the UV light.

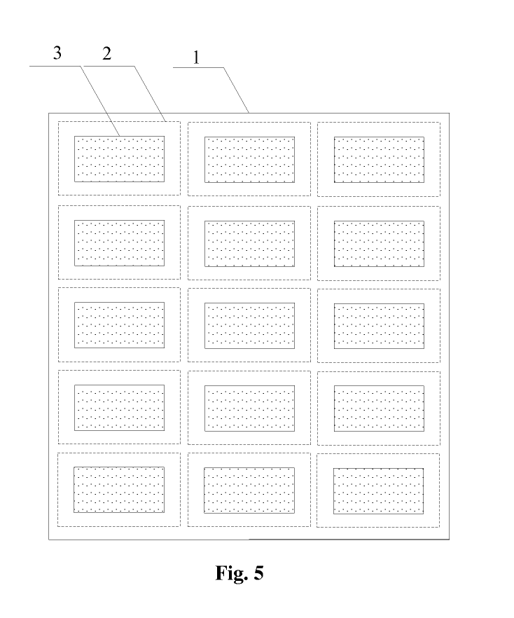

In this embodiment, the UV light having a wavelength ranging between 146 nm and 365 nm can be completely blocked by the mask. Therefore, when the substrate coated with the alignment film and covered with the mask is irradiated by using the UV light having a wavelength ranging between 146 nm and 365 nm, the redundant portions of the alignment film on the substrate that are located outside the predetermined alignment film region can be substantially peeled off by the UV light. Thereafter, the mask is removed and the desired alignment film is obtained in the predetermined alignment film region, as shown in FIG. 5. In FIG. 5, regions defined by rectangular boxes 3 each are the predetermined alignment film region coated with the alignment film.

Because the redundant portions of the alignment film on the substrate 1 that are located outside the predetermined alignment film region are peeled off by the UV light, the alignment film coated in the predetermined alignment film region that is finally obtained has regular edges and an even thickness. Therefore, coating of the sealant will not be affected, and the image quality of the LCD device will not be degraded due to edge irregularities and uneven thicknesses of the alignment film.

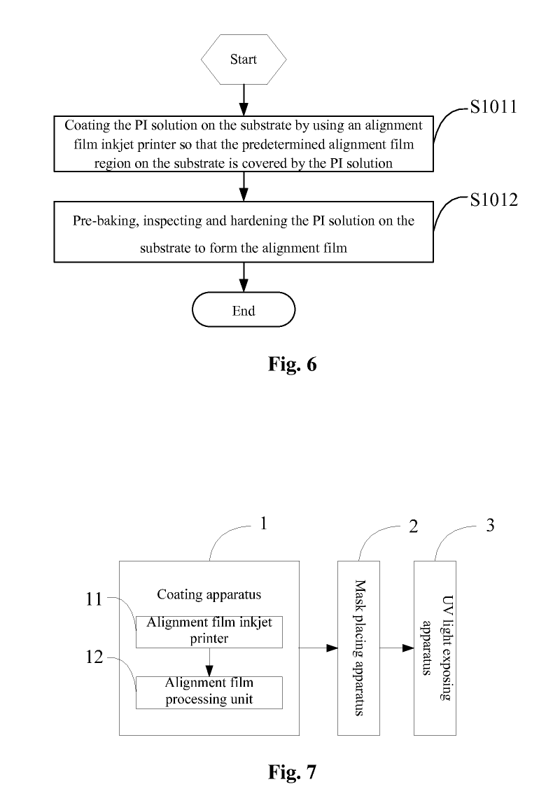

Specifically, as shown in FIG. 6, the step S101 comprises:

Step S1011: coating the PI solution on the substrate by using an alignment film inkjet printer so that the predetermined alignment film region on the substrate is covered by the PI solution; and

Step S1012: pre-baking, inspecting and hardening the PI solution on the substrate to form the alignment film.

For convenience of coating, the PI solution may be directly coated on the whole substrate. This embodiment can effectively make an improvement on the problems of printing offsets, sawtooth-like edge irregularities and uneven film thicknesses caused when the alignment film is coated by an alignment film inkjet printer according to the alignment film design rule in the prior art. This improves the positioning precision of the alignment film region and the quality of the alignment film, thus improving the image quality of the LCD device.

As shown in FIG. 7, the present disclosure further provides a system for forming an alignment film region through UV light exposure, which comprises: a coating apparatus 1, a mask placing apparatus 2 and a UV light exposing apparatus 3.

The coating apparatus 1 is adapted to coat a PI solution on a substrate to form an alignment film.

The mask placing apparatus 2 is adapted to place a pre-fabricated mask above the substrate so that the predetermined alignment film region is masked by the mask.

The UV light exposing apparatus 3 is adapted to irradiate a UV light on the whole substrate covered by the mask to peel off portions of the alignment film on the substrate that are located outside the predetermined alignment film region.

The coating apparatus 1 comprises: an alignment film inkjet printer 11 for coating the PI solution on the substrate, and an alignment film processing unit 12 for pre-baking, inspecting and hardening the PI solution on the substrate to form the alignment film.

The system for forming an alignment film region through UV light exposure according to this embodiment operates in the following way.

Firstly, the PI solution is coated on the whole substrate by using the alignment film inkjet printer 11 of the coating apparatus 1 so that the predetermined alignment film region on the substrate is covered by the PI solution; and then, the PI solution on the substrate is pre-baked, inspected and hardened by the alignment film processing unit 12 of the coating apparatus 1 to form the alignment film. The substrate array that is completely coated with the alignment film is shown in FIG. 3. As shown in FIG. 3, the entire substrate 1 is divided into a plurality of displaying units of a fixed size; rectangular boxes 2 each represent one of the displaying units of the fixed size; and rectangular boxes 3 each represent a boundary line of an effective displaying region on one of the displaying units of the fixed size that must be covered by the alignment film (i.e., the region in which each of the rectangular boxes 3 is located is the predetermined alignment film region). A coating site (not shown) of a sealant is reserved between each of the rectangular boxes 2 and a corresponding one of the rectangular boxes 3. In this embodiment, the alignment film is firstly coated on the entire substrate 1 shown in FIG. 3 uniformly.

In other embodiments, it may also be possible to coat the alignment film in each of the displaying units of the fixed size so long as the coated alignment film covers the predetermined alignment film region completely (i.e., so long as the PI solution for fabricating the alignment film covers the region in which each of the rectangular boxes 3 of FIG. 3 is located).

The PI solution may be comprised of polyimide and a solvent of DMA, NMP or BC.

The aforesaid pre-baking process means to vaporize the solvent of DMA, NMP or BC in the PI solution.

The hardening process means to heat the PI solution to a high temperature so that polyimide in the PI solution undergoes a cyclopolymerization reaction to form polyamide that is a long-chain large-molecule solid polymer having many branched chains. An angle included between one of the branched chains and the main chain in the polymer molecule is a pretilt angle of a guiding layer. The branched chains of the polymer and liquid crystal molecules have a strong acting force therebetween, which can anchor the liquid crystal molecules and may have the liquid crystal molecules arranged in the direction of the pretilt angle.

When the substrate is completely coated with the alignment film, the pre-fabricated mask is placed by the mask placing apparatus 2 above the alignment film of the substrate. The mask has the same size as the predetermined alignment film region on the substrate. The mask is fabricated according to the size of the predetermined alignment film region.

When covering the alignment film of the substrate, the mask shall be close to the substrate as far as possible to prevent light leakage due to a too large gap but shall not contact the alignment film on the substrate. In this embodiment, a distance between the mask and the substrate is usually set to be smaller than or equal to 50 μm. The predetermined alignment film region on the substrate is completely covered by the mask (i.e., edges of the mask are substantially aligned with edges of the predetermined alignment film region) so that the predetermined alignment film region on the substrate can be masked by the mask, as shown in FIG. 4. In FIG. 4, black regions each are the mask.

Then, the UV light exposing apparatus 3 is used to irradiate the UV light on the whole substrate covered with the mask so as to peel off portions of the alignment film on the substrate that are located outside the predetermined alignment film region.

The UV light generally has a wavelength ranging between 146 nm and 365 nm. The UV light can excite oxygen (O₂) in the air into ozone (O₃) having strong oxidizability, and also break a molecular chain of polyamide of the large-molecule solid polymer into small polyamide molecules. The polyamide molecules are oxidized by ozone into such gases as H₂O₂, CO₂ and NOₓ, which are exhausted by an exhaust apparatus that is additionally provided. In this way, the portions of the alignment film can be removed by using the UV light.

In this embodiment, the UV light having a wavelength ranging between 146 nm and 365 nm can be completely blocked by the mask. Therefore, when the substrate coated with the alignment film and covered with the mask is irradiated by using the UV light having a wavelength ranging between 146 nm and 365 nm, the redundant portions of the alignment film on the substrate that are located outside the predetermined alignment film region can be substantially peeled off by the UV light. Thereafter, the mask is removed and the desired alignment film is obtained in the predetermined alignment film region, as shown in FIG. 5. In FIG. 5, regions defined by rectangular boxes 3 each are the predetermined alignment film region coated with the alignment film.

Because the redundant portions of the alignment film on the substrate 1 that are located outside the predetermined alignment film region are peeled off by the UV light, the alignment film coated in the predetermined alignment film region that is finally obtained has regular edges and an even thickness. Therefore, coating of the sealant will not be affected, and the image quality of the LCD device will not be degraded due to edge irregularities and uneven thicknesses of the alignment film.

The method and the system for forming an alignment film region through UV light exposure according to the embodiments of the present disclosure can effectively make an improvement on the problems of printing offsets, sawtooth-like edge irregularities and uneven film thicknesses caused when the alignment film region is coated by an alignment film inkjet printer according to the alignment film design rule in the prior art. This improves the positioning precision of the alignment film region and the quality of the alignment film, thus improving the image quality of the LCD device.

What described above are only preferred embodiments of the present disclosure but are not intended to limit the scope of the present disclosure. Accordingly, any equivalent structural or process flow modifications that are made on basis of the specification and the attached drawings or any direct or indirect applications in other technical fields shall also fall within the scope of the present disclosure.

What is claimed is:

1. A method for forming an alignment film region through ultraviolet (UV) light exposure, comprising the following steps of:
coating a polyimide (PI) solution on a substrate to form an alignment film that covers a predetermined alignment film region on the substrate;
placing a mask fabricated according to the predetermined alignment film region above the alignment film so that the predetermined alignment film region is masked by the mask;
peeling off portions of the alignment film on the substrate that are located outside the predetermined alignment film region through exposure to a UV light; and
removing the mask to obtain the alignment film in the predetermined alignment film region.

2. The method of claim 1, wherein the step of coating a PI solution on a substrate to form an alignment film comprises:
coating the PI solution on the substrate by using an alignment film inkjet printer so that the predetermined alignment film region on the substrate is covered by the PI solution; and
pre-baking, inspecting and hardening the PI solution on the substrate to form the alignment film.

3. The method of claim 1, wherein the PI solution is comprised of polyimide and a solvent of DMA, NMP or BC.

4. The method of claim 1, wherein a distance between the mask and the substrate is smaller than or equal to 50 micrometers (μm).

5. The method of claim 4, wherein the UV light has a wavelength ranging between 146 nanometers (nm) and 365 nm.

6. The method of claim 1, wherein the substrate is a thin film transistor (TFT) substrate and/or a color filter (CF) substrate.

7. A system for forming an alignment film region through UV light exposure, comprising:
a coating apparatus for coating a PI solution on a substrate to form an alignment film;
a mask placing apparatus for placing a pre-fabricated mask above the substrate so that the predetermined alignment film region is masked by the mask; and
a UV light exposing apparatus for irradiating a UV light on the whole substrate covered by the mask to peel off portions of the alignment film on the substrate that are located outside the predetermined alignment film region.

8. The system of claim 7, wherein the coating apparatus comprises: an alignment film inkjet printer for coating the PI solution on the substrate, and an alignment film processing unit for pre-baking, inspecting and hardening the PI solution on the substrate to form the alignment film.

9. The system of claim 7, wherein the PI solution is comprised of polyimide and a solvent of DMA, NMP or BC.

10. The system of claim 7, wherein a distance between the mask and the substrate is smaller than or equal to 50 μm.

11. The system of claim 7, wherein the UV light has a wavelength ranging between 146 nm and 365 nm.

12. The system of claim 7, wherein the substrate is a TFT substrate and/or a CF substrate.
